(19) United States
(12) Patent Application Publication
(10) Pub. No.: US 2007/0063074 A1
(43) Pub. Date: Mar. 22, 2007

(54) Fuel injection valve for internal combustion engines

(76) Inventor: Jochen Mertens, Reutlingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/557,729

(22) PCT Filed: Dec. 6, 2003
(86) PCT No.: PCT/DE03/04022

§ 371 Date: Nov. 21, 2005

(30) Foreign Application Priority Data
May 19, 2003 (DE) 10322826.8

(51) Int. Cl. F02M 63/00; F02M 47/02; F02M 41/16

(52) U.S. Cl. 239/533.2; 239/96; 239/88

(57) ABSTRACT

A fuel injection valve for internal combustion engines having a valve seat at which at least one injection opening originates. A valve needle with a valve sealing face embodied thereon cooperates with the valve seat to close and open the at least one injection opening. First and second sealing edges are embodied on the valve sealing face; in the closing position of the valve needle the first sealing edge rests sealingly on the valve seat upstream of the at least one injection opening and the second sealing edge rests sealingly on the valve seat downstream of the at least one injection opening. On its face end toward the valve seat the valve needle has a recess such that a sealing lip is formed which can be deformed elastically or plastically inward by the contact of the valve needle on the valve seat and at which the second sealing edge is embodied.

### PRIOR ART

The invention is based on a fuel injection valve for internal combustion engines of the kind known for instance from German Patent Disclosure DE 103 15 821 A1. The known fuel injection valve has a valve seat at which at least one injection opening originates. A pistonlike valve needle, embodied as an outer valve needle is disposed in the fuel injection valve. The valve needle has a valve sealing face, with which the valve needle cooperates with the valve seat by its longitudinal motion in such a way that the injection openings can be opened or closed thereby, in order to control the fuel injection into the combustion chamber. Two sealing edges are embodied on the valve sealing face; upon contact of the valve needle with the valve seat, the first sealing edge comes into contact with the valve seat upstream and the second sealing edge comes into contact with the valve seat downstream of the at least one injection opening. The intent is thereby to seal off the injection openings completely from the rest of the fuel in the fuel injection valve.

In the known fuel injection valve, however, difficulties arise in this respect: To achieve secure sealing off of both sealing edges, the sealing edges are disposed such that upon the motion of the valve needle toward the valve sealing face, the second sealing edge comes to rest on the valve seat first, and only at a higher closing force and a corresponding elastic deformation on the end of the valve needle toward the valve seat does the first sealing edge come to rest as well. The forces that must be employed for this purpose are considerable: The radially inward deformation of the valve needle can be done only by upsetting of the entire needle, hence the strong forces. The closing force on the valve needle must, in addition to the hydraulic pressure that in common rail applications typically acts constantly on the valve needle, also bring this force that effects the sealing to bear as well, which lowers the effective opening pressure. Particularly for the case where fatigue or plastic deformation of the valve needle, over the course of the service life, changes the force required to seal off the valve needle, the opening force and hence the opening pressure changes as well, which causes a change in the injection characteristic of the fuel injection valve.

### ADVANTAGES OF THE INVENTION

The fuel injection valve according to the invention having the definitive characteristics of claim 1 has the advantage over the prior art that sealing off of the injection openings upstream and downstream is achieved by the valve needle; compared with the incident closing forces, only slight forces are required for this. To that end, the valve needle of the invention, on its face end toward the valve seat, has a recess, such that a sealing lip that is deformable inward either elastically or plastically is formed, at which lip the second sealing edge is embodied. Because of this recess, the sealing lip is easily deformable, without overly reducing the wall thickness of the valve needle in the event that the valve needle is embodied as a hollow needle. As a result, the stability of the valve needle is preserved with simultaneously good sealing off of the injection openings. Also advantageously, the recess that forms the sealing lip can also be employed in a valve needle that has no longitudinal bore. Because of the otherwise impossible sealing both upstream and downstream of the injection openings, the result is a further reduction in the fuel-filled volume, which communicates with the combustion chamber via the injection openings in the intervals between injections. As a result, the hydrocarbon emissions from the engine are reduced markedly.

Advantageous features of the subject of the invention are possible by means of the dependent claims.

If the valve needle is embodied as a hollow needle with a corresponding longitudinal bore, then the recess is advantageously embodied by a radial enlargement on the end of the longitudinal bore toward the valve seat. The embodiment as a chamfer is especially advantageous, so that the recess has the shape of a truncated cone. This can easily be accomplished in production, and the second sealing edge is embodied precisely in the form of a ridge, and simultaneously the second sealing edge forms the end of the valve needle toward the valve seat. Depending on the demands made of the valve needle and on its stability, still other shapes of the recess may also be advantageous. What is decisive is the weakening of the end of the valve needle toward the combustion chamber, on which end the second sealing edge is embodied, such that a sealing lip is formed that is elastic enough that it yields inward when even slight force is expended.

If the valve needle is embodied in solid form and has no longitudinal bore, then the recess, viewed in cross section, may be embodied in the same way. The elastic sealing lip again assures suitable sealing off of the injection openings.

It is especially advantageous to embody the sealing lip in triangular form, viewed in cross section. As a result, on the outer edge the second sealing edge results automatically and can thus be manufactured precisely.

### DRAWING

The prior art and various exemplary embodiments of the fuel injection valve of the invention are shown in the drawing.

FIG. 1 shows a fuel injection valve according to the invention in longitudinal section, with two valve needles guided one inside the other;

FIG. 2 is an enlargement of FIG. 1 in the detail marked II;

FIG. 3 shows an enlarged view of FIG. 2 in the detail marked III; the embodiments in FIGS. 2 and 3 represent the prior art;

FIG. 4, in the same view as FIG. 2, shows a first exemplary embodiment of the invention;

FIG. 5 shows the detail marked V of FIG. 4 in an enlarged view;

FIGS. 5a, 5b, 5c, 5d, 5e and 5f, in the same view as FIG. 5, show further exemplary embodiments of the invention;

FIG. 6, in longitudinal section, shows a fuel injection valve known from the prior art, in which only one valve needle is provided;

FIG. 7 shows an enlarged view of the detail marked VII of FIG. 6;

FIG. 8, in the same view as FIG. 7, shows a further exemplary embodiment of the invention; and

FIG. 9 shows the detail of FIG. 8 marked IX, in an enlarged view.

### DESCRIPTION OF THE EXEMPLARY EMBODIMENTS

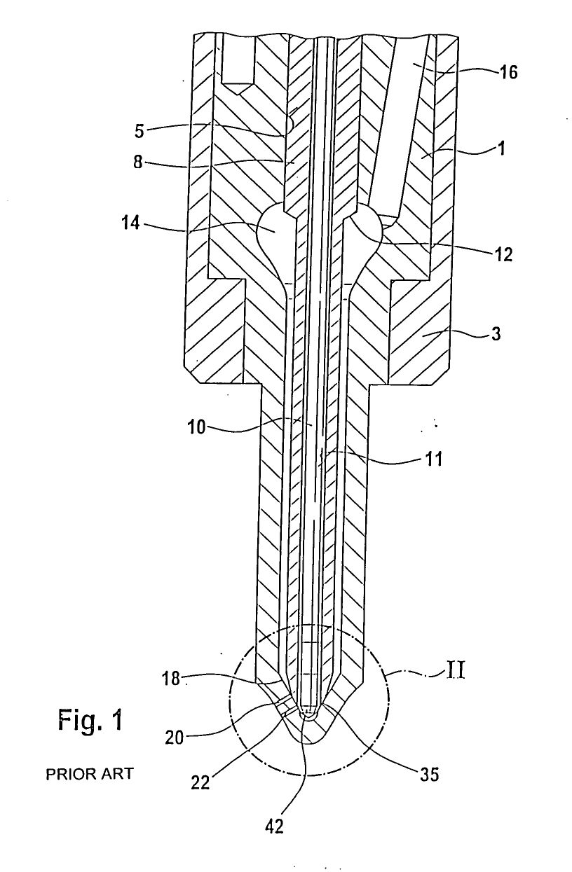

In FIG. 1, a fuel injection valve according to the invention is shown in longitudinal section. A bore 6 is embodied in a valve body 1 and is defined, on its end toward the combustion chamber, by a substantially conical valve seat 18. By means of a lock nut 3, the valve body 1 is pressed against a retaining body, not shown in the drawing. Injection openings 20 and inner injection openings 22 originate at the valve seat 18 and, in the installed position of the fuel injection valve, they discharge into the combustion chamber of the engine. A valve needle 8 is disposed in the bore 5 and is guided in the bore 5 in a region facing away from the valve seat. The valve needle 8, beginning at the guided portion, narrows toward the valve seat 18, forming a pressure shoulder 12, and on its end toward the combustion chamber it merges with a likewise substantially conical valve sealing face 35, with which the valve needle 8 cooperates with the valve seat 18. Between the valve needle 8 and the wall of the bore 5, a pressure chamber 14 is embodied, which is radially enlarged at the level of the pressure shoulder 12. An inflow conduit 16 extending in the valve body 1 discharges into the radial enlargement of the pressure chamber 14, and by way of this conduit the pressure chamber 14 can be filled with fuel at high pressure.

A longitudinal bore 11 is embodied in the valve needle 8, and an inner needle 10 is longitudinally displaceable in this bore. The inner needle 10, on its end toward the valve seat, has an inner valve sealing face 42, with which it likewise cooperates with the valve seat 18. The valve needle 8 and the inner needle 10 cooperate with the valve seat 18 in such a way that upon contact of the valve needle 8 with the valve seat 18, the pressure chamber 14 is sealed off from the injection openings 20, 22. If the valve needle 8, driven by the hydraulic force on the pressure shoulder 12 and counter to a closing force, lifts from the valve seat 18, then fuel flows out of the pressure chamber 14 between the valve sealing face 35 and the valve seat 18 through to the injection openings 20 and is injected through them into the combustion chamber. In this event, the inner needle 10 at least initially remains in its closing position, in which it is likewise held by a closing force. Once the valve needle 8 has lifted from the valve seat 18, the inner needle 10 is also acted upon by fuel pressure, which via corresponding pressure faces on the inner needle 10 leads to an opening force oriented counter to the closing force. Depending on how the closing force is controlled, the inner needle 10 now likewise lifts from the valve seat 18 and uncovers the inner injection openings 22, or else, if the closing force is high enough, this inner needle remains in its closing position. In this way, fuel can be injected into the combustion chamber either through all the injection openings 20, 22 or through only some of the injection openings 20. By increasing the closing forces or throttling the delivery of fuel into the pressure chamber 14, the injection is terminated, and the valve needle 8 and the inner needle 10 each slide in the longitudinal direction back into their respective closing positions, in which they are in contact with the valve seat 18.

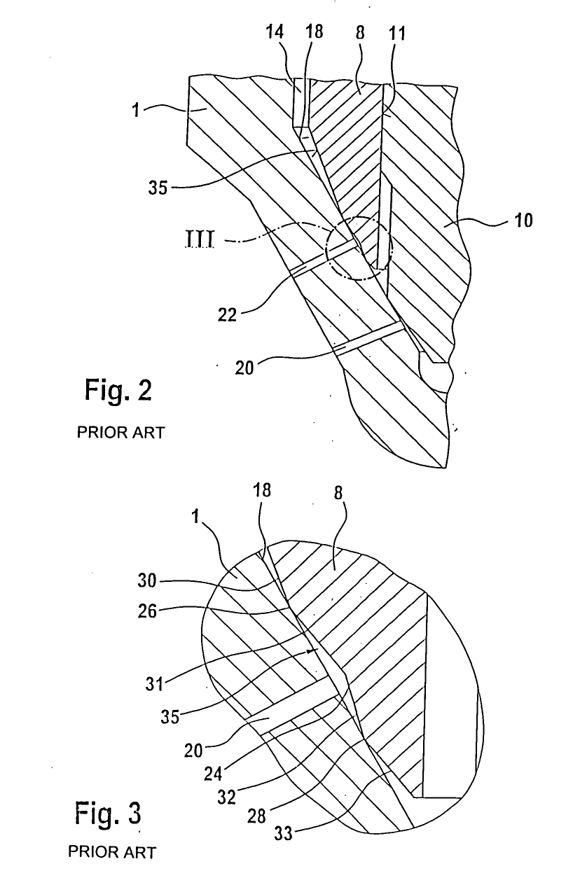

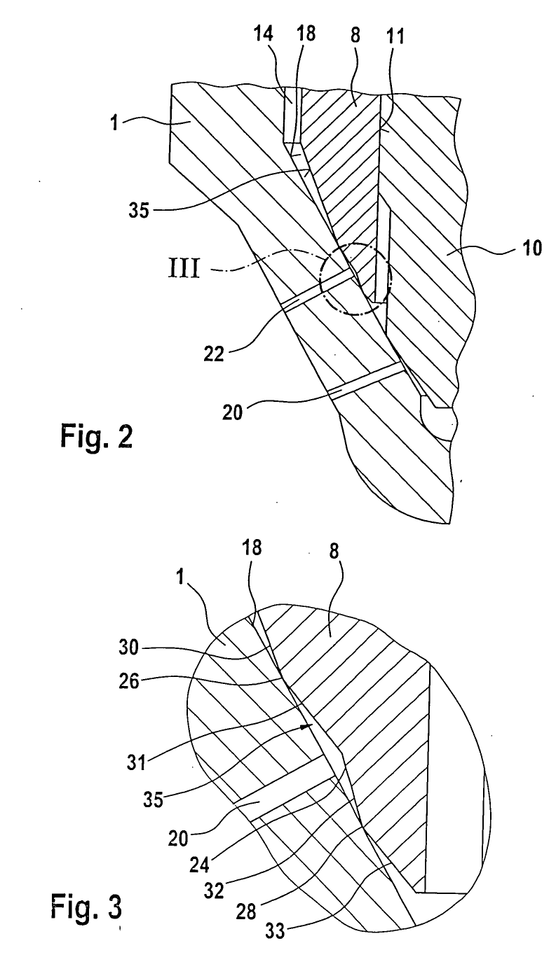

FIG. 2 shows an enlarged view of the detail marked II in FIG. 1, in the region of the valve seat; the embodiment shown here is equivalent to the prior art already known. The valve needle 8, with its valve sealing face 35, covers the injection openings 20. The sealing is intended to be against both the pressure chamber 14 and the intermediate chamber that remains between the inner needle 10 and the valve needle 8. Otherwise, high hydrocarbon emissions can occur because of fuel from this intermediate chamber that gets into the combustion chamber through the injection openings 20 in the intervals between injections. To achieve such sealing, it is known from the prior art to equip the valve sealing face 35 with a first sealing edge 26 and a second sealing edge 28. To that end, the valve sealing face 35 is divided up into a first conical face 30, a second conical face 31, a third conical face 32, and a fourth conical face 33; the first sealing edge 26 is formed at the transition from the first conical face 30 to the second conical face 31, and the second sealing edge 28 is formed at the transition from the third conical face 32 to the fourth conical face 33. In FIG. 3, the detail marked III in FIG. 2 is shown, still further enlarged. To achieve sealing off at both sealing edges 26, 28 and to assure an adequate pressure per unit of surface area in both regions, it is known to embody the second sealing edge 28 such that, upon the motion of the valve needle 8 toward the valve seat 18, it becomes seated first on the valve seat 18. Only after a radially inward elastic deformation of the end, toward the valve seat, of the valve needle 8 by the closing force that presses the valve needle 8 against the valve seat 18 does the first sealing edge 26 come into contact with the valve seat 18 as well. However, this requires strong forces, even though the width of the valve needle 8 in the region of the second sealing edge amounts to only about 0.15 mm.

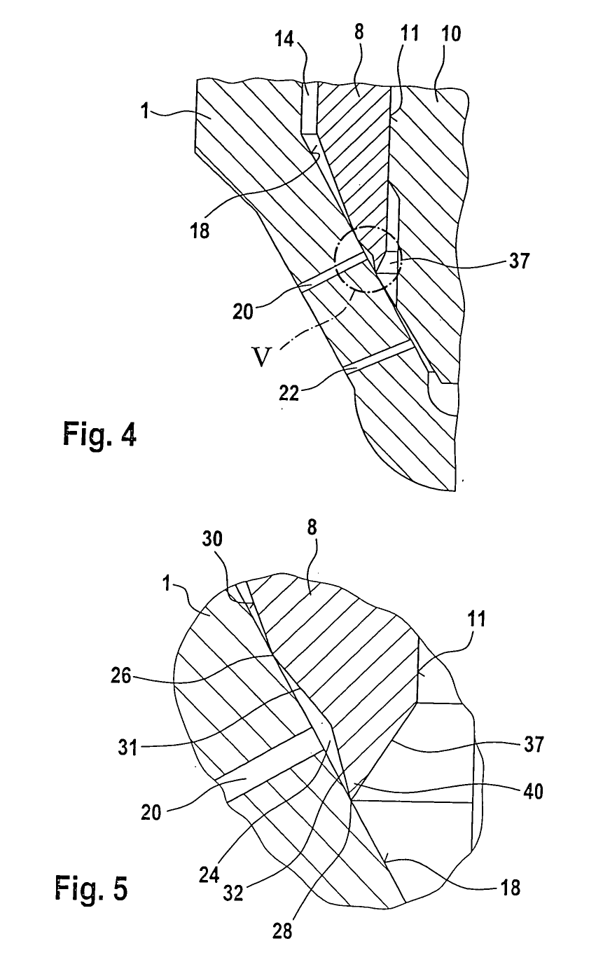

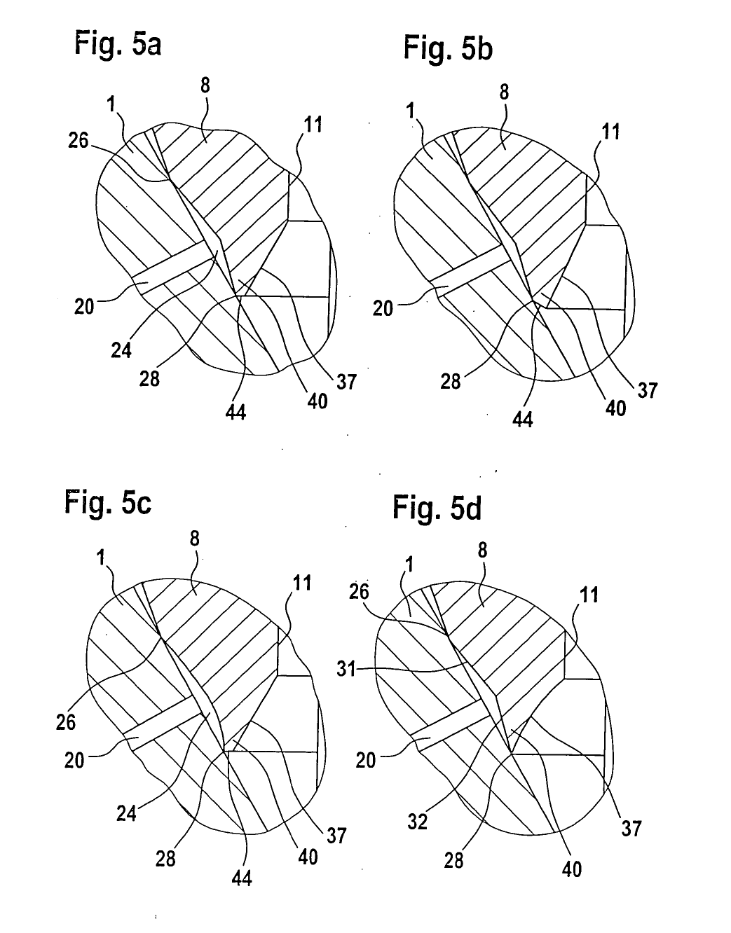

To overcome this problem, the fuel injection valve of the invention is constructed for instance as shown in FIG. 4. In it, the identical components are identified with the same reference numerals as in FIGS. 1 through 3, so that the full content of the description of those figures applies here as well. A recess 37, formed here by a radial enlargement of the longitudinal bore 11, is embodied. On the end of the valve needle 8 toward the combustion chamber. FIG. 5 shows an enlarged view in the region of the recess 37. This recess 37 has the shape of a truncated cone and is embodied such that a sealing lip 40 is formed, on which the second sealing edge 28 is embodied. Viewed in cross section, the sealing lip 40 is approximately triangular and is therefore so flexible, on its outer edge that forms the second sealing edge 28, that it can deform radially inward in response to even slight forces. Thus if the sealing edges 26, 28 are disposed as in the already known exemplary embodiment of FIGS. 2 and 3, then upon the closing motion of the valve needle 8, the second sealing edge 28 becomes seated on the valve seat 18 first. The sealing lip 40 formed by the recess 37 is now pressed radially inward by even only slight axial forces and thus makes it possible for the first sealing edge 26 to become seated on the valve seat 18 and to seal off the injection openings 20. The wall thickness of the valve needle 8 in the region of the annular groove 24 is hardly weakened at all, so that practically the same stability of the valve needle 8 is attained as before. The fourth conical face 33 is omitted because of the embodiment of the recess 37.

In the description of the further exemplary embodiments shown in FIGS. 5a through 5f, only the differences from FIG. 5 will be addressed; parts that are unchanged will not be described in further detail. In FIG. 5a,the recess 37 is still in the form of a truncated cone, but it is embodied such that an annular face 44 is formed on the end, toward the valve seat, of the valve needle 8. The second sealing edge 28 is embodied on the outer edge of this annular face 44, which makes the tip of the valve needle 8 somewhat more stable, although also somewhat less flexible. In FIG. 5b,an exemplary embodiment is shown in which the annular face 44 is embodied in somewhat inclined fashion, so that the second sealing edge 28 no longer forms the end, toward the valve seat, of the valve needle 8. However, the recess 37 here also assures that adequate flexibility exists in this region.

FIG. 5c shows a further exemplary embodiment, in which the recess 37 is again embodied such that an annular face 44 is formed. The annular groove 24 here is not formed by two conical faces; instead, it has a rounded course. As a result, depending on the embodiment of the annular groove 24, somewhat greater flexibility of the sealing lip 40 is obtained.

FIG. 5d shows a further exemplary embodiment, in which the recess 37 is no longer embodied frustoconically but rather as bell-shaped, so that the sealing lip 40 becomes even thinner and is thus formed with still greater flexibility. The annular groove 24 is again formed here by two conical faces.

In the exemplary embodiment shown in FIG. 5e, a shoulder 34 is embodied between the second conical face 31 and the third conical face 32. As a result, the sealing lip 44 can be purposefully weakened and the flexibility thus further enhanced. It is also possible, as FIG. 5f shows, instead of sharp-edged transitions between the conical faces 31, 32 and the shoulder 34, to round the shoulder 34 and the third conical face 32, thus reducing notch stresses in this region.

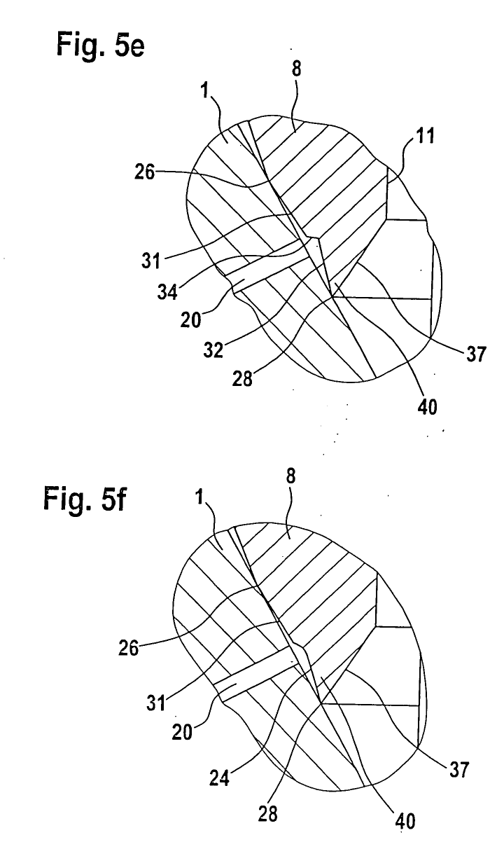

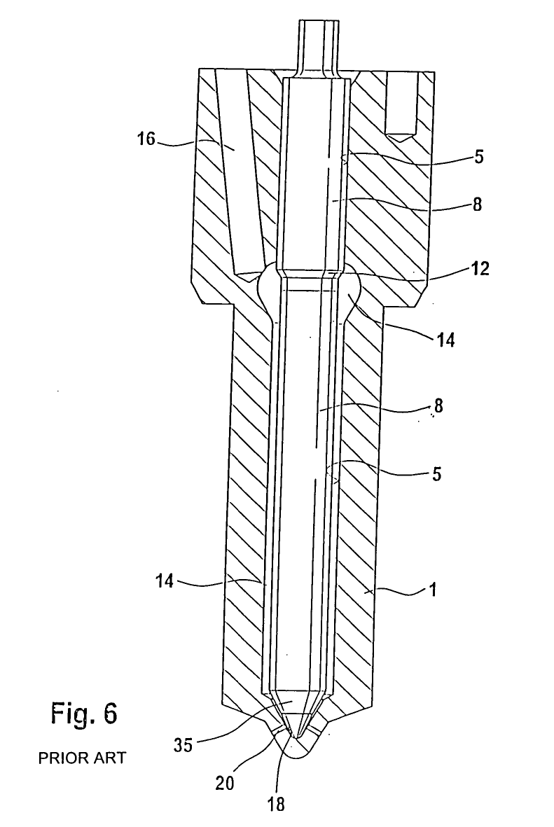

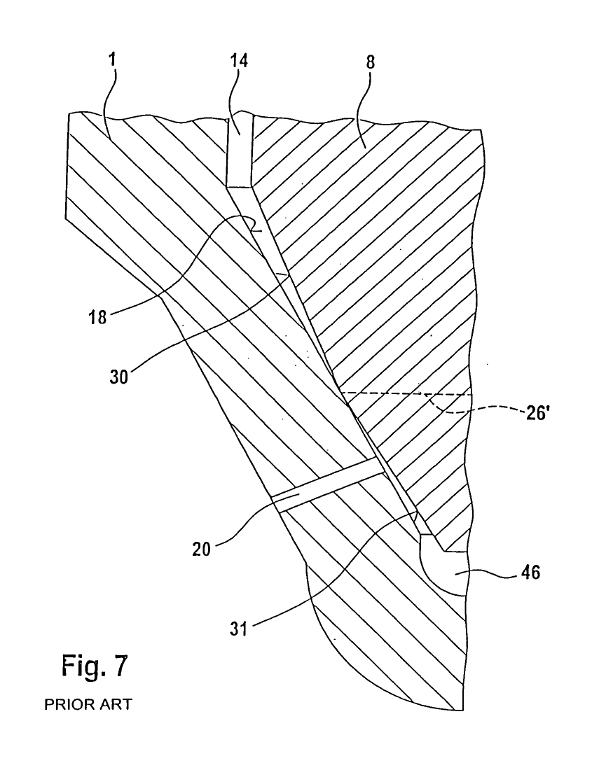

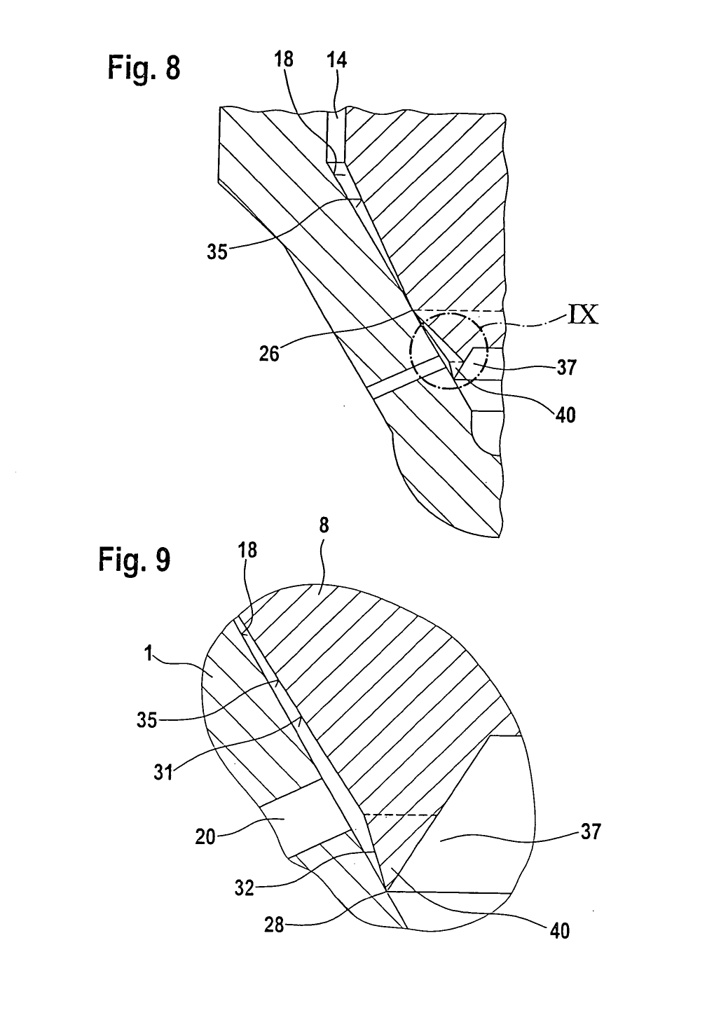

FIG. 6 shows a fuel injection valve which is known from the prior art. The construction is largely equivalent to that shown in FIG. 1, so that identical components are identified by the same reference numerals. To the extent that the components are identical to those of the exemplary embodiments described earlier herein, the description thereof is referred to. Here, the valve needle 8 has no longitudinal bore, and thus the inner needle is omitted. The valve needle 8 controls the fuel flow out of the pressure chamber 14 to the injection openings 20 in a known way, by moving in the longitudinal direction. FIG. 7 is an enlarged view of the region of the valve seat 18 in FIG. 6. The valve sealing face 35 has a first conical face 30 and a second conical face 31, which in terms of their opening angle are embodied such that between them a first sealing edge 26′ is embodied, between which and the valve seat 18 the sealing off of the injection openings 20 from the pressure chamber 14 takes place. The conical valve seat 18 does not come to a sharp point toward the end of the valve body 1 toward the combustion chamber but instead discharges into a residual volume 46, which essentially has the shape of a hemisphere. The residual volume 46 also serves as a tool exit in the manufacture of the valve seat 18. This residual volume 46 remains in communication with the combustion chamber via the injection openings 20 when the fuel injection valve is closed, which has an adverse effect on the hydrocarbon emissions from the engine. To reduce this residual volume 46, the valve needle 8 of the invention is embodied as in the exemplary embodiment of the invention shown in FIG. 8. On the end toward the valve seat, a frustoconical recess 37 is embodied, such that a sealing lip 40 is formed. The sealing lip 40 here seals off the injection openings 20 from the residual volume 46, and as a result, the fuel-filled volume that is in communication, as before, with the injection openings 20 is reduced to the volume of the annular groove 24.

Here as well, the recess 37 may assume various shapes, such as a bell shape, as shown in FIG. 5d, or a hemispherical shape. All the shapes of the annular groove 24 shown in FIGS. 5a through 5f can be employed here as well.

Besides the pure elastic deformation of the sealing lip 40 in the closing event of the valve needle 8, it may also be provided that the sealing lip 40 is plastically deformable. Upon the first closing event of the novel fuel injection valve, the sealing lip 40 is deformed to such an extent that the two sealing edges 26, 28 rest on the valve seat 18; in that case, even the slight force, which is still necessary for deforming the sealing lip 40 inward, can then be dispensed with. It is also possible for the deformation of the sealing lip 40 to be effected plastically-elastically; that is, upon the first closing event, some of the total deformation that is required to put the first sealing edge 26 into contact with the valve sealing face 18 is effected plastically, which further reduces the subsequently necessary forces for the elastic deformation of the sealing lip 40.

1-17. (canceled)

18. In a fuel injection valve for internal combustion engines, in which a valve seat is embodied, at which seat at least one injection opening originates, and having a valve needle, which with a valve sealing face embodied on the valve needle cooperates with the valve seat and thereby closes and opens the at least one injection opening, and having a first sealing edge embodied on the valve sealing face and a second sealing edge, where in the closing position of the valve needle, the first sealing edge rests sealingly on the valve seat upstream of the at least one injection opening and the second sealing edge rests sealingly on the valve seat downstream of the at least one injection opening, the improvement wherein the valve needle comprises a recess on its face end toward the valve seat, the recess forming a sealing lip at which the second sealing edge is embodied, which sealing lip can be deformed elastically or plastically inward by the contact of the valve needle on the valve seat.

19. The fuel injection valve according to claim 18, wherein the valve needle comprises a longitudinal bore, and wherein the recess on the end toward the valve seat of the longitudinal bore is embodied as a radial enlargement.

20. The fuel injection valve according to claim 19, wherein the recess is embodied in the form of a truncated cone.

21. The fuel injection valve according to claim 19, wherein the recess has a bell shape.

22. The fuel injection valve according to claim 19, wherein the recess has the shape of a hemisphere.

23. The fuel injection valve according to claim 18, wherein the second sealing edge is embodied on the end toward the valve seat of the valve needle.

24. The fuel injection valve according to claim 23, wherein the valve needle, on its end toward the valve seat, comprises an annular face.

25. The fuel injection valve according to claim 18, wherein the recess is embodied frustoconically.

26. The fuel injection valve according to claim 18, wherein the recess has a bell shape.

27. The fuel injection valve according to claim 18, wherein the recess has the shape of a hemisphere.

28. The fuel injection valve according to claim 18, wherein the sealing lip, viewed in cross section, essentially has a triangular shape.

29. The fuel injection valve according to claim 19, wherein the sealing lip, viewed in cross section, essentially has a triangular shape.

30. The fuel injection valve according to claim 18, further comprising an annular groove extending between the first sealing edge and the second sealing edge.

31. The fuel injection valve according to claim 19, further comprising an annular groove extending between the first sealing edge and the second sealing edge.

32. The fuel injection valve according to claim 30, wherein the annular groove is formed by two conical faces.

33. The fuel injection valve according to claim 31, wherein the annular groove is formed by two conical faces.

34. The fuel injection valve according to claim 32, further comprising a shoulder embodied between the two conical faces.

35. The fuel injection valve according to claim 18, wherein the valve seat is embodied substantially conically.

36. The fuel injection valve according to claim 18, wherein the valve sealing face is embodied substantially conically.

37. The fuel injection valve according to claim 18, wherein, upon motion toward the valve seat, the valve needle first rests with its second sealing edge on the valve seat, and the first sealing edge does not come into contact with the valve seat until after an elastic or plastic deformation of the sealing lip.
